(19) United States
(12) Patent Application Publication
(10) Pub. No.: US 2010/0154208 A1
(43) Pub. Date: Jun. 24, 2010

(54) Method and system for the re-conditioning of a vehicle headlight fixture or headlight fixture lens or any combination thereof

(76) Inventor: Wayne M. Torcivia, Ronkonkoma, NY (US)

Correspondence Address: Wayne M. Torcivia, 60 Creighton Ave., Ronkonkoma, NY, 11779, US

(21) Appl. No.: 12/655,888

(22) Filed: Jan. 11, 2010

Related U.S. Application Data
(63) Continuation of application No. 11/787,949, filed on Apr. 19, 2007, now abandoned.

(51) Int. Cl. B23P 6/00

(52) U.S. Cl. 29/700

(57) ABSTRACT

A system and method for the reconditioning of a vehicle headlight fixture or vehicle headlight fixture lens. The present invention includes at least one mode of transportation and a plurality of components useful for reconditioning a vehicle headlight fixture or vehicle headlight fixture lens, thus providing a portable method and system to reconditioning of a vehicle headlight fixture or vehicle headlight fixture lens.

### CROSS REFERENCE

Patent and patent applications Month & Year Name U.S. Pat. No. 3,659,307 May 1972 Vitou U.S. Pat. No. 7,163,446 January 2007 Cole U.S. Pat. No. 4,080,685 March 1978 Vander pool U.S. Pat. No. 4,661,182 April 1987 Lerner U.S. Pat. No. 5,248,521 September 1993 Yamane et al. U.S. Pat. No. 5,443,604 August 1995 Stowell U.S. Pat. No. 5,569,346 October 1996 Marshall U.S. Pat. No. 6,001,793 December 1999 Figdore et al. U.S. Pat. No. 6,244,707 June 2001 Faubl U.S. Pat. No. 6,398,396 June 2002 Nestell et al U.S. Pat. No. 6,428407 August 2002 Elder U.S. Pat. No. 6,583,097 June 2003 Mcdonald U.S. Pat. No. 6,6385,63 October 2003 Mcgee et al. U.S. Pat. No. 6,831,049 December 2004 Torres Moreno U.S. Pat. No. 6,846,567 January 2005 Ekinaka et al. U.S. Pat. No. 6,855,210 February 2005 Dostic et al. U.S. Pat. No. 6,984,612 January 2006 Maillie U.S. Pat. No. 7,045,001 May 2006 Kropp et al. 2003/0211962 November 2003 Held, 111 et al. 2004/0121927 June 2004 Mcdonald 2004/0157758 August 2004 Adickes 2004/0235699 November 2004 Torres Moreno 2006/0024427 February 2006 Clyde et al.

### OTHER REFERENCES

1. Clearstar Coatings Corp., collection of screen shots from Internet—10 pages total, date unknown. Cited by other. (Referenced in U.S. Pat. No. 7,163,446 to Cole, et al.) Available at http://www.clearstarcorp.com.

2. Material Safety Data Sheet for Brite Lites Lens Cleaner, two pages, date unknown. Cited by other. (Referenced in U.S. Pat. No. 7,163,446 to Cole, et al.) Available at http://www.lensrestorer.com/instruct.htm.

3. “Brite Lites Plastic Lens Restorer”, five pages from Internet, date unknown. Cited by other. (Referenced in U.S. Pat. No. 7,163,446 to Cole, et al.—available at http://www.lensrestorer.com/instruct.htm).

4. Material Safety Data Sheet for Aqua-Buff 2000, two pages May 19, 1993. Cited by other. (Referenced in U.S. Pat. No. 7,163,446 to Cole, et al.—available at http://www.aqua-buff.com/site/47859/product/AB2000).

5. Material Safety Data Sheet for Clearstar High Performance Gloss Clear Protective Coating, two pages, Aug. 16, 2001. Cited by other. (Referenced in U.S. Pat. No. 7,163,446 to Cole, et al.—available at http://www.clearstarcorp.com).

6. “Headlight Restoration Kits”, Details King' Supply Online Mall, three pages from Internet, GoEmerchant, 2003. Cited by other. (Referenced in U.S. Pat. No. 7,163,446 to Cole, et al.—available at http://www.detailking.com).

7. Crystal View Chemicals, Inc., “Directions For Headlight Restoration Kit”, two pages from Internet, 2004. Cited by other. (Referenced in U.S. Pat. No. 7,163,446 to Cole, et al.—available at http://www.myheadlight.com).

8. Lens Renew, “New Life For Your Plastic Headlight Lenses”, two pages from Internet, 2004. Cited by other. (Referenced in U.S. Pat. No. 7,163,446 to Cole, et al.—available at http://www.lensrenew.com).

9. Clearstar Coatings Corp., “Liquid Laminate Manual”, 13 pages, 2004. Cited by other. (Referenced in U.S. Pat. No. 7,163,446 to Cole, et al.) Available at http://www.clearstarcorp.com.

10. Rightlook Automotive Reconditioning Equipment & Training, “Clearlights Headlight Restoration Kit”, two pages from Internet, 2005. Cited by other. (Referenced in U.S. Pat. No. 7,163,446 to Cole, et al.—available at http://www.rightlook.com/ auto-detailing-hands-on-training.html).

### RESEARCH AND DEVELOPMENT SPONSORSHIP STATEMENT

We have not received any financial support from any outside agent or agency towards the research and development of the device herein described. We have financed all the research and development of the the device herein described with our own funds.

### BACKGROUND OF THE INVENTION

As a vehicle that uses a headlight fixture or vehicle headlight fixture lens is exposed to any types of environmental conditions or wear and tear over time, the aesthetics, illumination efficiency, illumination projection efficiency for assisting of night vision operation is greatly diminished, and becomes a hazard for a vehicle operator, any passengers, pedestrians or any other vehicles who may come in contact with that vehicle that uses an inferior vehicle headlight fixture lens.

There are an abundance of solutions offered to the public that are effective methods, products or cleaning systems for this existing hazard. The problem with these solutions, are that they, for example, must be applied by the consumer, and are not user friendly, use hazardous chemicals, and are applied in most cases, in adverse environmental conditions rendering these products ineffective. Furthermore, the desired outcome is never achieved allowing the hazard still to exist, subjecting themselves and others to a severe potential event involving personal injury, death, or property damage or any combination thereof, from decreased vehicle night vision operation.

The solution to this problem is providing a diversified system and method as a service to the public incorporating a mode of transportation into a method for reconditioning a headlight fixture or a vehicle headlight fixture lens in many diversified capacities. It is thus an object of the present invention to provide a method and system for reconditioning a vehicle headlight fixture or vehicle headlight fixture lens that will improve the operation of a vehicle headlight fixture or vehicle headlight fixture lens, thus eradicating the initial hazard of decreased vehicle night vision operation.

### BRIEF SUMMARY OF THE INVENTION

The invention is a portable system and method for the reconditioning of a vehicle headlight fixture or headlight fixture lens or any combination thereof.

### DETAILED DESCRIPTION OF THE DRAWINGS

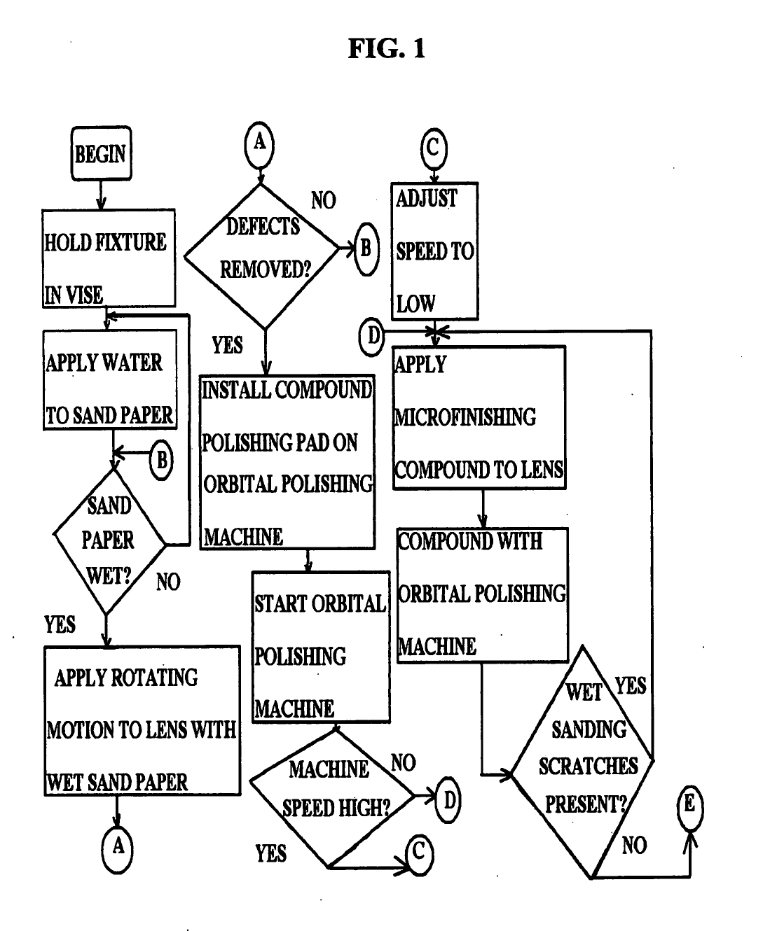

FIG. 1: MANUAL POLISHING PROCESS ALGORITHM PART ONE.

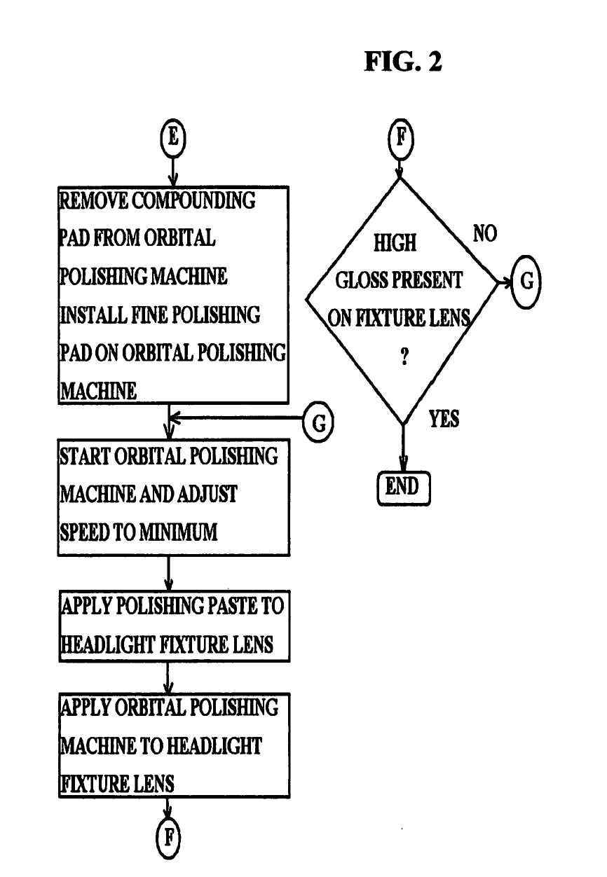

FIG. 2: MANUAL POLISHING PROCESS ALGORITHM PART TWO.

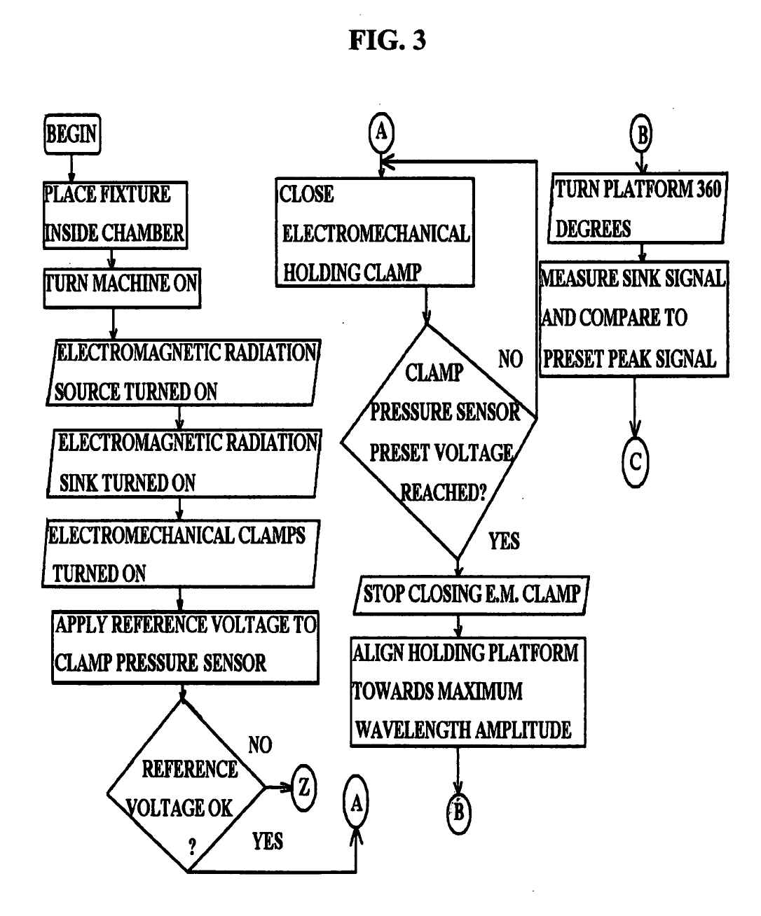

FIG. 3: AUTOMATED POLISHING PROCESS COMPUTER ALGORITHM FLOWCHART PART ONE.

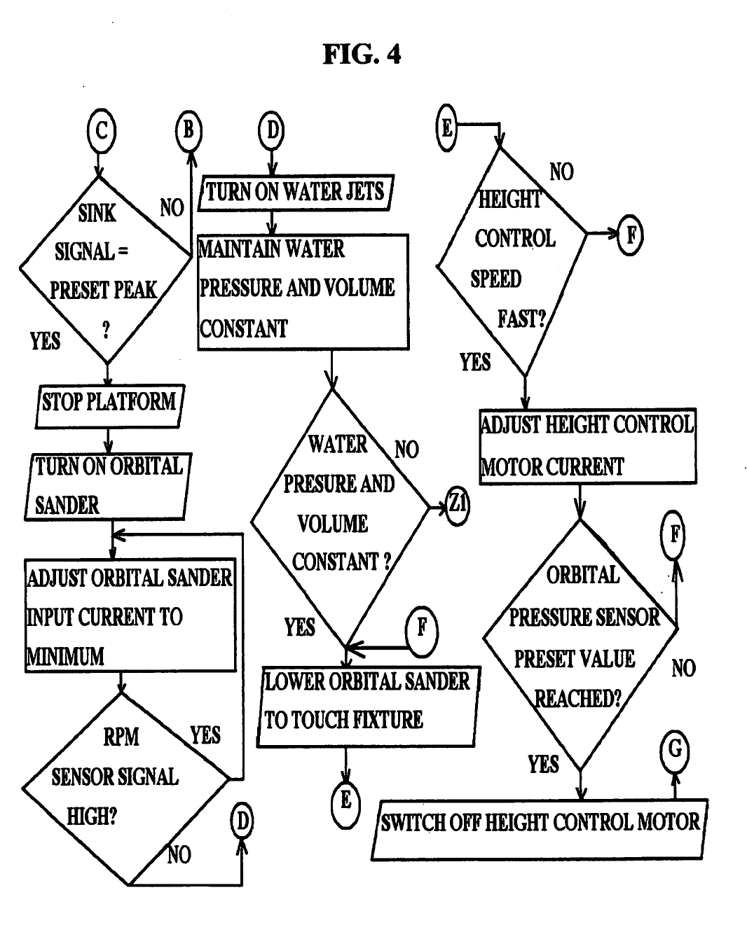

FIG. 4: AUTOMATED POLISHING PROCESS COMPUTER ALGORITHM FLOWCHART PART TWO.

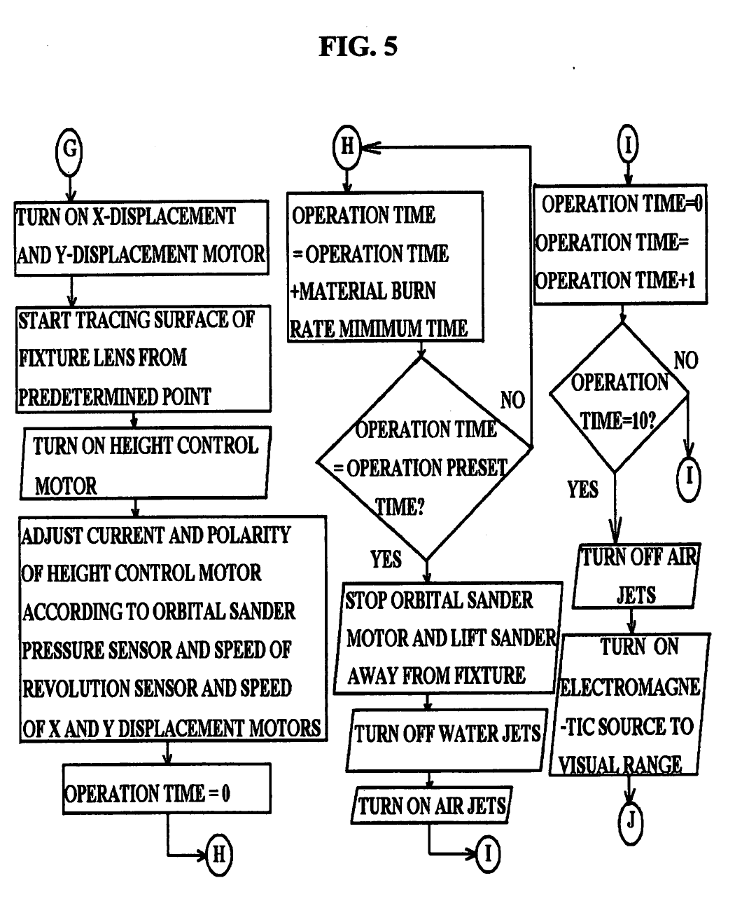

FIG. 5: AUTOMATED POLISHING PROCESS COMPUTER ALGORITHM FLOWCHART PART THREE.

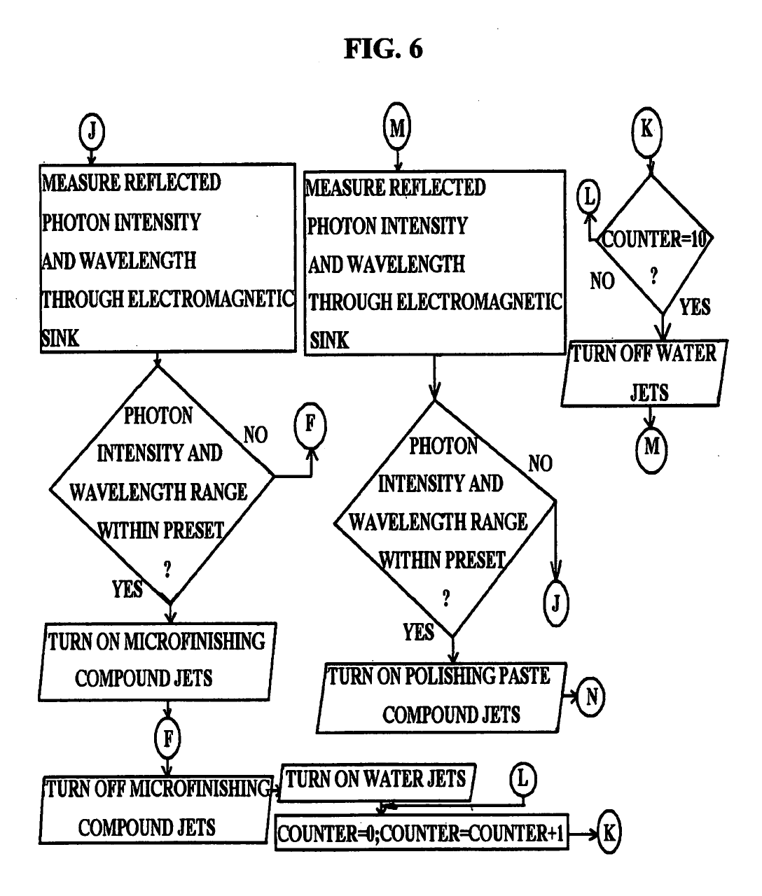

FIG. 6: AUTOMATED POLISHING PROCESS COMPUTER ALGORITHM FLOWCHART PART FOUR.

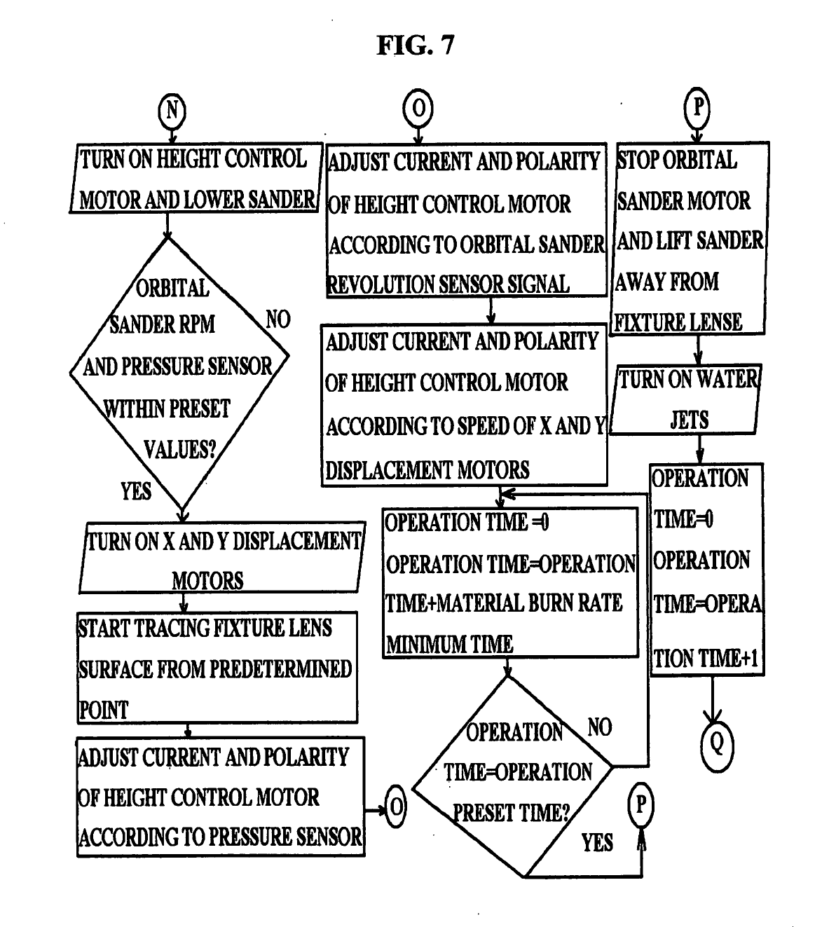

FIG. 7: AUTOMATED POLISHING PROCESS COMPUTER ALGORITHM FLOWCHART PART FIVE.

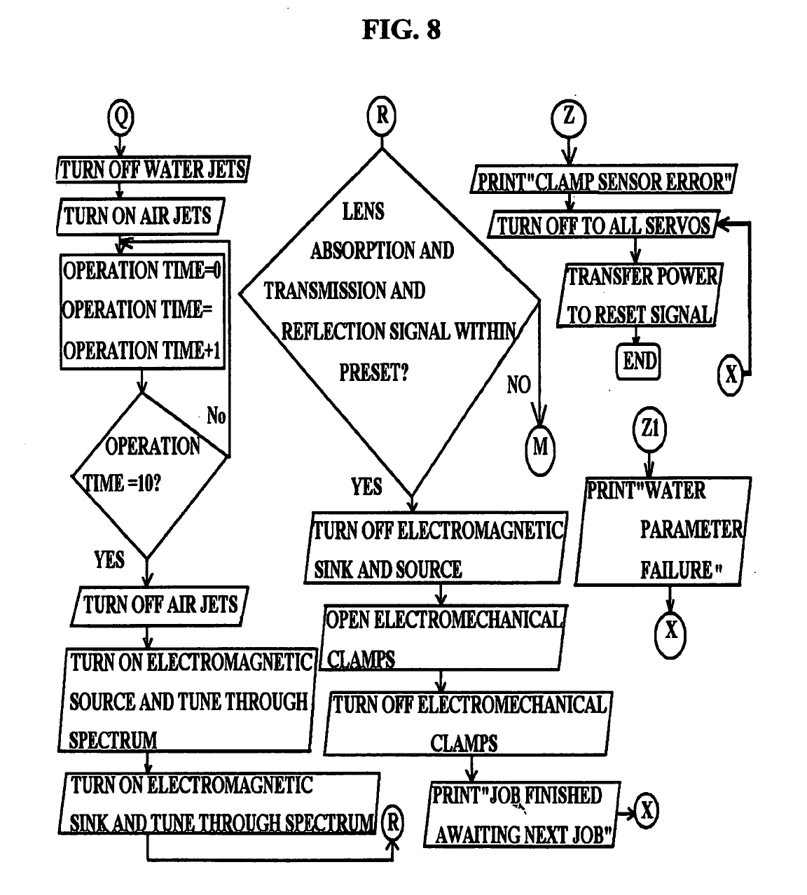

FIG. 8: AUTOMATED POLISHING PROCESS COMPUTER ALGORITHM FLOWCHART PART SIX.

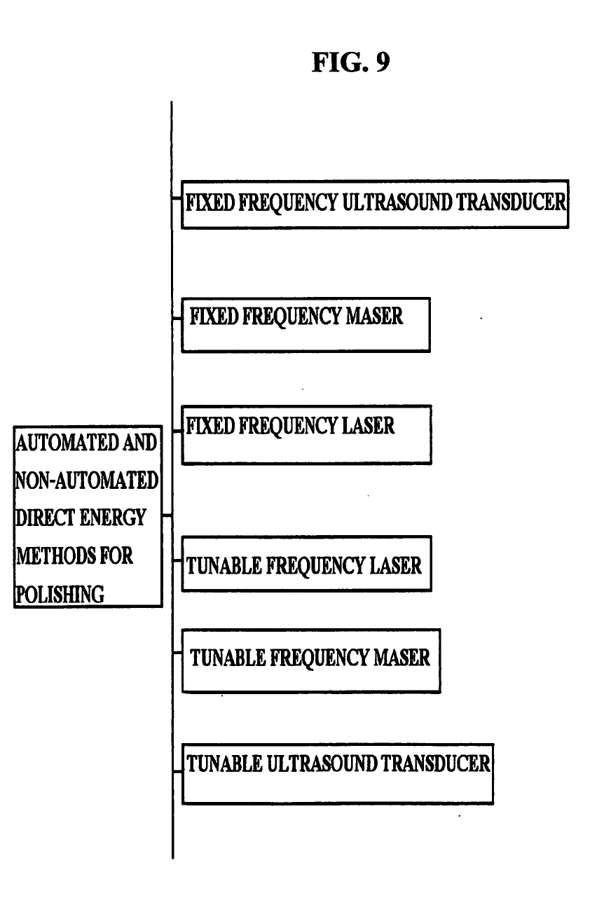

FIG. 9: AUTOMATED TUNED LASER/MASER/ULTRASOUND POLISHING PROCESS HIERARCHICAL CHART.

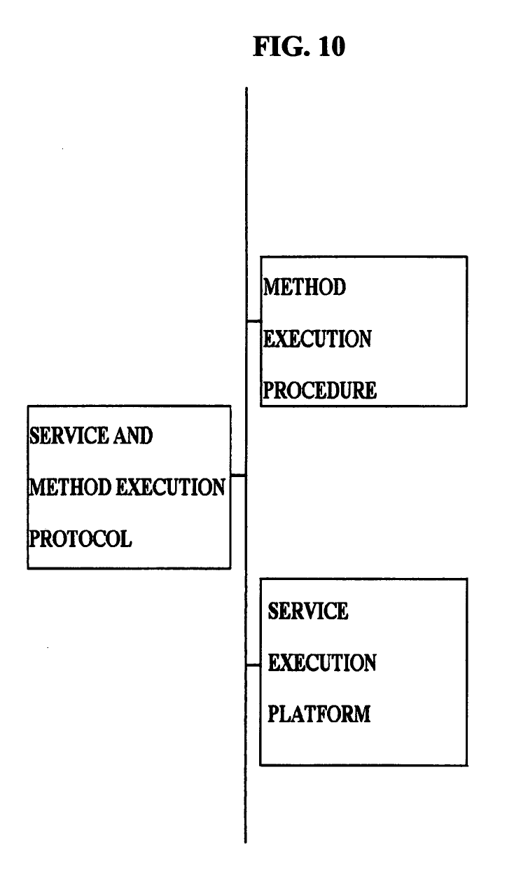

FIG. 10: SERVICE AND METHOD EXECUTION PROTOCOL HIERARCHICAL ORGANIZATION CHART.

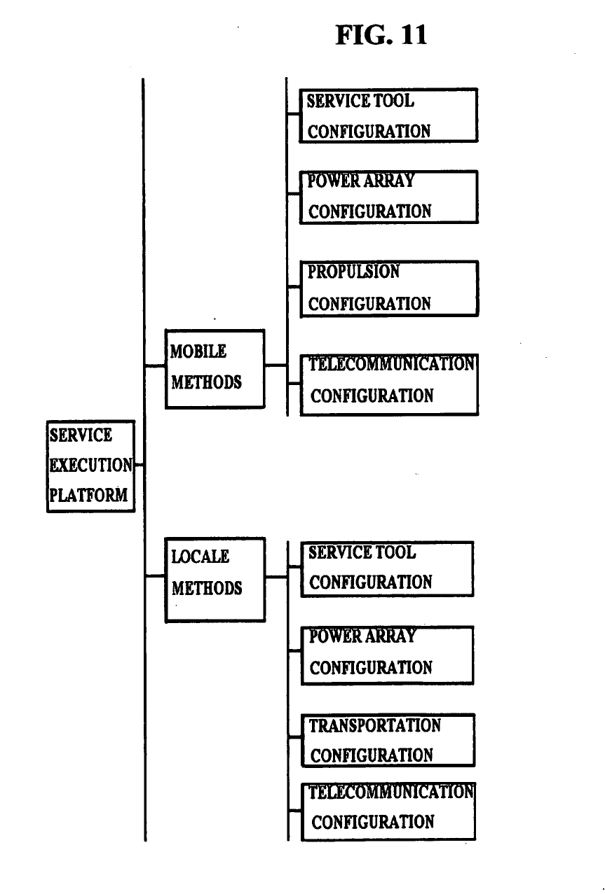

FIG. 11: SERVICE EXECUTION PLATFORM AND ASSOCIATED METHODS HIERARCHICAL ORGANIZATION CHART.

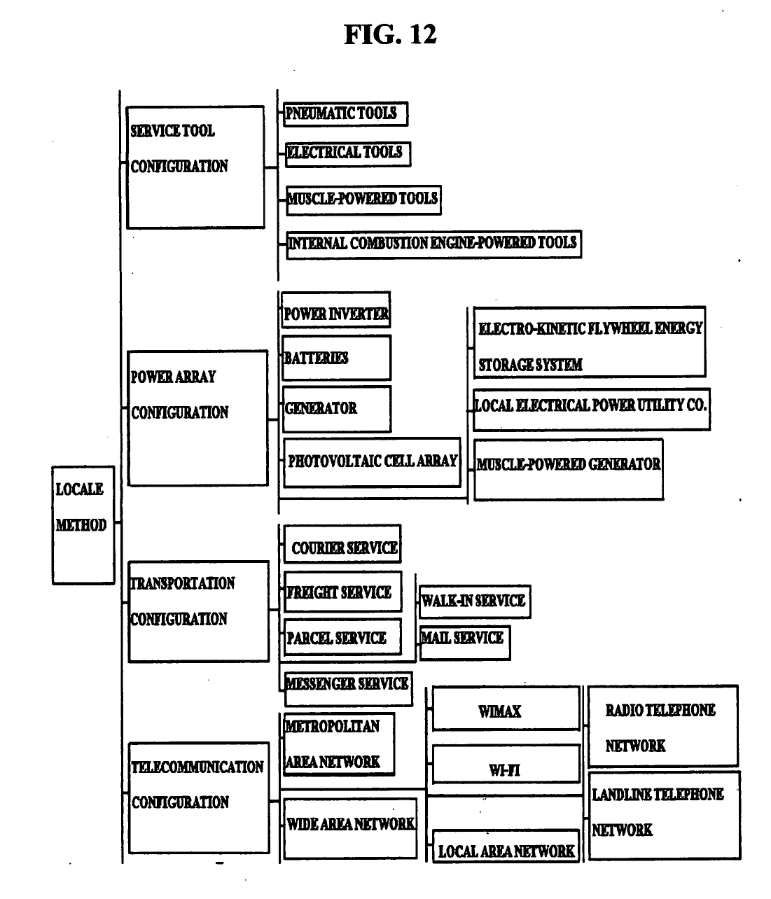

FIG. 12: SERVICE EXECUTION PLATFORM LOCALE METHODS HIERARCHICAL ORGANIZATION CHART.

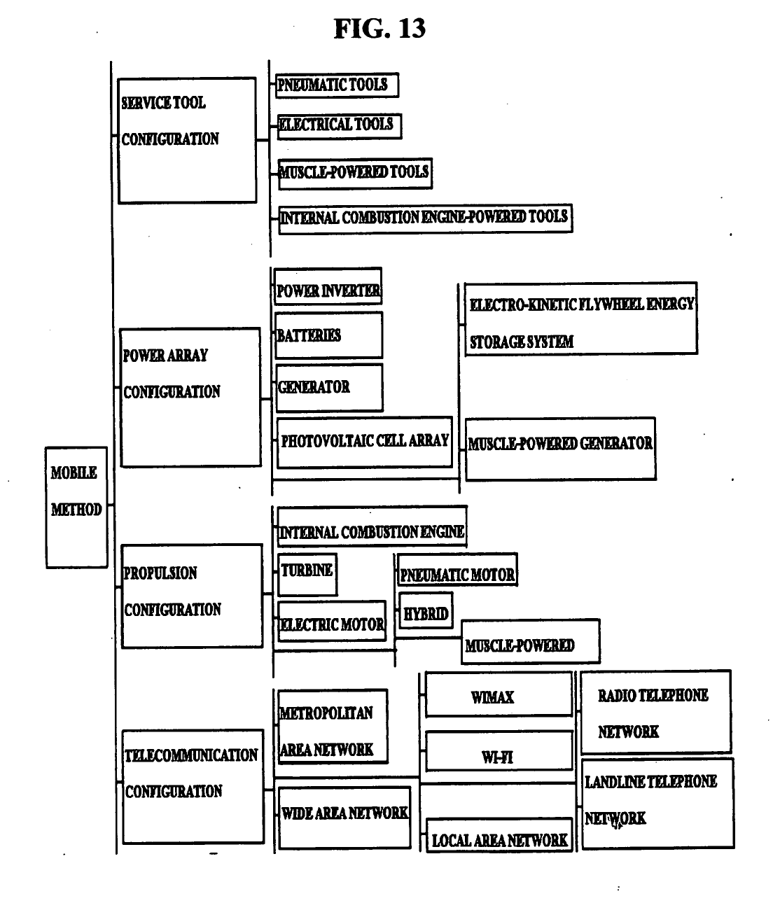

FIG. 13: SERVICE EXECUTION PLATFORM MOBILE METHODS HIERARCHICAL ORGANIZATION CHART.

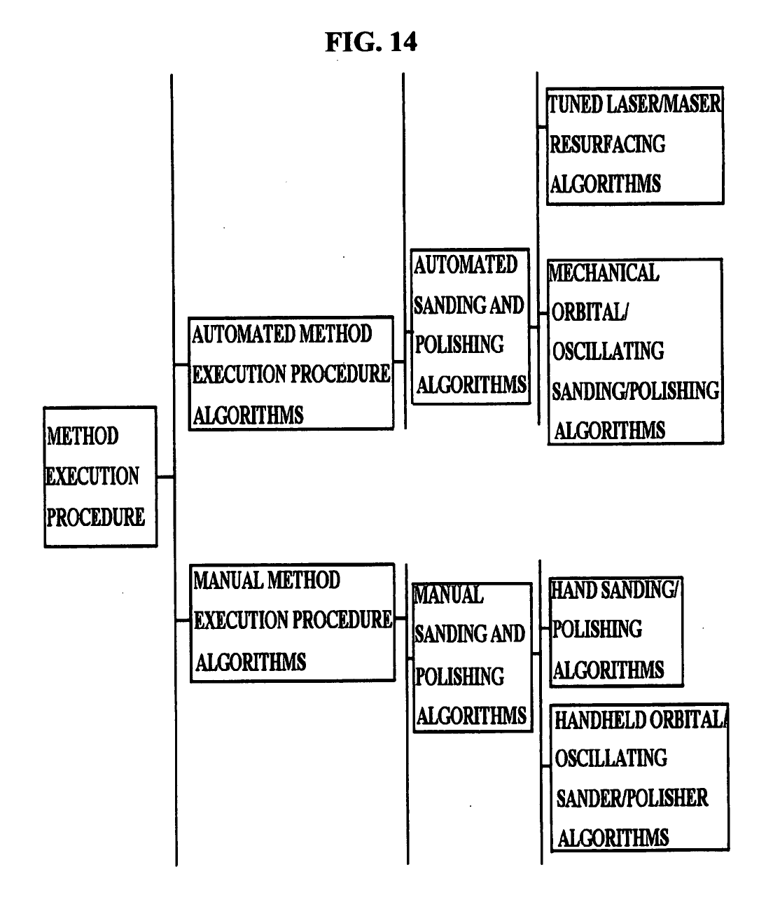

FIG. 14: METHOD EXECUTION PROCEDURE HIERARCHICAL ORGANIZATION CHART.

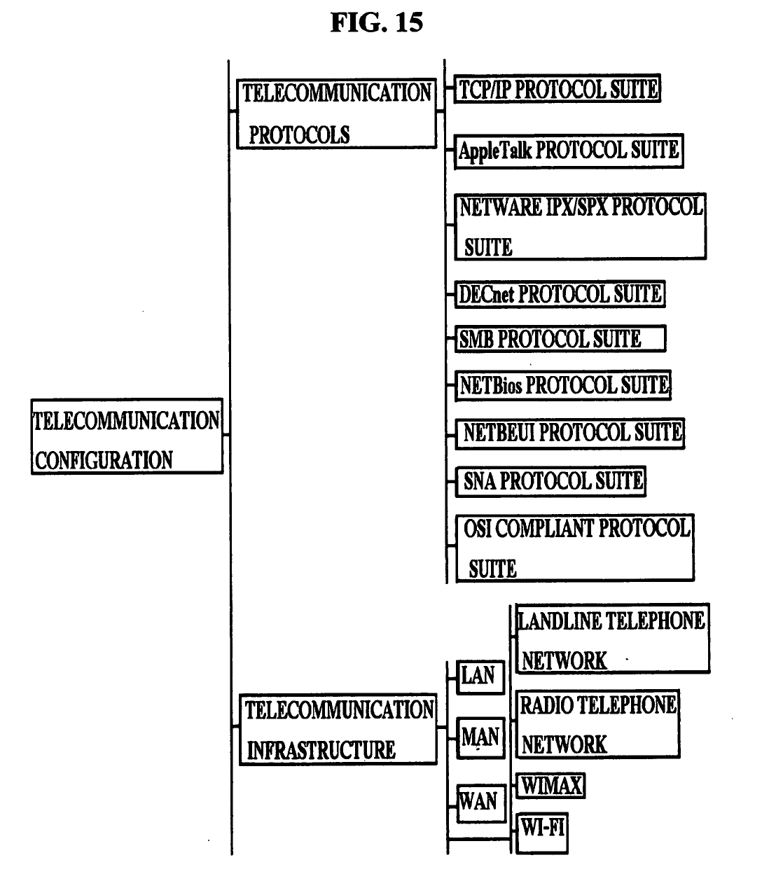

FIG. 15: TELECOMMUNICATION CONFIGURATION AND ASSOCIATED TELECOMMUNICATION PROTOCOLS HIERARCHICAL ORGANIZATION CHART.

### DETAILED DESCRIPTION OF THE INVENTION

Many vehicle manufacturers utilize a vehicle headlight fixture or vehicle headlight fixture lens for the purpose of expanding the designed function of a vehicles capacity to operate in an environment that requires a sufficient amount of light, projected from that vehicle in order to function in the vehicles full capacity. As a wide variety of vehicles possess a vehicle headlight fixture or vehicle headlight fixture lens for this purpose, the exposure to environmental conditions and wear and tear on a vehicle headlight fixture or vehicle headlight fixture lens present the problem of aesthetics, vehicle headlight fixture illumination and vehicle headlight fixture illumination projection, adversely affected and diminishing the operating capacity of a vehicle headlight fixture or vehicle headlight fixture lens or any combination thereof.

There exists many systems and methods for remedying this problem, and are very effective in eradicating this problem, but have no means of providing a portable means for reconditioning a vehicle headlight fixture or vehicle headlight fixture lens, as provided by the method and system of the present invention.

Heretofore unknown was any system method for reconditioning a vehicle headlight fixture or vehicle headlight fixture using a vehicle as the primary transportation and platform combined with the necessary tools and equipment and materials for applying the system and method of the present invention, thus providing a portable means of reconditioning a vehicle headlight fixture or vehicle headlight fixture lens.

Also unknown was a portable method or system for reconditioning vehicle headlight fixtures and vehicle headlight fixture lenses which use a telecommunications configuration as a component combined with any system, method or methods, using the vehicle, tools and equipment as a whole operating service, for eradicating this problem.

The solution for this problem is the instant invention which provides a portable system and method for the reconditioning of a vehicle headlight fixture or vehicle headlight fixture lens. Indeed, in one embodiment of the present invention a method and system is provided for reconditioning a vehicle headlight fixture or vehicle headlight fixture lens which can be transported to and from a location, on or away from a location.

In one particular embodiment of the present invention, a method and system is provided for reconditioning a vehicle headlight fixture or vehicle headlight fixture lens which can be transported to and from a location via a mail service such as a courier service, a freight service, a messenger service, or any combination thereof. The aforementioned mail services, may be utilized in connection with the method and system of the instant invention for shipping and receiving various components used in connection with method and system of the present invention for reconditioning a vehicle headlight fixture or headlight fixture lens which may be transported to and from a location.

In addition to that discussed above, the method and system of the present invention is useful for improving the aesthetics of a vehicle headlight fixture or headlight fixture lens, and also improving vehicle headlight fixture illumination and vehicle headlight fixture illumination projection, as desired.

The method and system of the present invention for reconditioning a vehicle headlight fixture or vehicle headlight feature lens may be utilized with or without removing the vehicle headlight fixture or vehicle headlight fixture lens from a vehicle, to achieve the aforementioned desired outcome.

Each of the components of the method and system of the present invention including, for example, the vehicle, platform, tools and equipment, may vary due to different configurations. The method and system of the present invention may be utilized in a stationary or mobile capacity. When used in a mobile capacity, the method and system of the present invention may include an automobile such a van, box truck, pickup truck, or flatbed truck equipped with the tools and equipment required for the reconditioning of a vehicle headlight fixture or vehicle headlight fixture lens or any combination thereof.

In one embodiment of the present invention, the vehicle used to provide portability to the method and system described herein includes on board equipment which is mounted stationary to the platform or carried by the platform, depending on the transporting vehicle's platform configuration. The transporting vehicle may include various components useful for reconditioning vehicle headlight fixtures and vehicle headlight fixture lenses including, for example, (1) a generator, as an a/c electrical source; (2) an air compressor, as a source for compressed air for operating any pneumatic equipment; (3) a power inverter, in combination with a battery, as an a/c electrical power source: (4) a 12v battery, which is used in combination with the power inverter as an a/c electrical power source, an outside power source, comprised of a building in the vicinity using a/c electric power utilities as a source of power; (5) an electrical extension cord 100 ft length, 50 ft length, 25 ft length, 10 ft length, or combination thereof, used to connect to the primary power source, for operating any electrically driven equipment; (6) an oscillating, an orbital, a pneumatic type, or a/c or dlc electrically operated variable speed, sanding or polishing machine, used for compound polishing, wet sanding, final finish polishing; (7) a box of 25 sheets of 3M 1500, 1000, 600, 400, grit wet sanding paper or any combination thereof, for the removal of oxidation or minute scratches, from a vehicle headlight fixture or vehicle headlight fixture lens or any combination thereof; (8) a micro finishing compound, using a paste or liquid type, or any combination thereof, used for the removal of scratches caused by the wet sanding process; (9) a final finish polish, paste or liquid or any combination thereof, used for removing very fine compounding scratches; (10) a 2, 4, 6, 8, 10 inch diameter polishing pad; (11) an 8 oz squeeze bottle filled with water, for applying water to wet sanding paper at a location; (12) a laptop computer; equipped for Internet access, for receiving or sending information via e mail to a customer, or a manufacture; and (13) a cell phone, used for communicating to a potential customer, or a manufacturer.

Provided herein, is one of the many embodiments for the application of a method or system for the reconditioning of a vehicle headlight fixture or vehicle headlight fixture lens or any combination thereof. Proceeding with the first step, using a van as the preferred vehicle equipped with the necessary tools, equipment and platform of choice for applying a method for the restoration of a vehicle headlight fixture lens. The van may contain various components used in connection with the restoration of vehicle headlight fixtures and vehicle headlight fixture lenses including, for example, a gasoline operated mobile generator, an orbital type high or low speed a/c electrically operated polishing machine, a 100 ft a/c electrical cord, a sheet of 1500 grit wet sanding paper, an 8 oz squeeze bottle filled with water, an 80z bottle of 3M liquid micro finishing compound, an 802 bottle of 3M final finish liquid polish.

The second step is initiated using one sheet of the 1500 grit wet sand paper, in combination with the squeeze bottle of water, and applying a generous amount of water onto the sheet of wet sanding paper; always keeping the wet sanding paper wet and never allowing to dry.

The third step begins using the saturated wet sanding paper, and applying a rotating type motion against the oxidized vehicle headlight fixture lens until all oxidation or minute scratches present have been removed. Once this procedure has been accomplished, proceed to the next step.

The fourth step begins by removing the gasoline operated generator from the van, starting and plugging the 100 ft extension cord into the generator, and then plugging in the orbital high and low speed polisher into the receiving end of the extension cord, in the same process installing the 6 inch compound polishing pad to the a/c electrically operated orbital type polishing machine.

The fifth step begins by starting the orbital polishing machine, adjusting the speed to the lowest setting, while applying 4 dime size drops of the 3M micro finishing compound on to the vehicle headlight future lens.

The compounding process is then started in the sixth step by applying the orbital type polishing machine, equipped with the 6 inch compounding pad to the vehicle headlight fixture lens, applying compound as needed to remove the fine wet sanding scratches away, until a clear scratch free appearance is achieved.

In the seventh and final step, it is time to remove the compounding pad from the orbital polishing machine, and install on the orbital polishing machine, the fine polishing pad, repeating the prior step, and replacing the micro finishing compound with the 3M polishing paste, polishing until a high gloss is achieved on the vehicle headlight lens. The system and method of the present invention for the restoration of vehicle headlight fixtures and vehicle headlight fixture lenses may include using any mode of transportation in order to provide for portability.

To provide for portability, the system and method of the present invention may include a vehicle such as (a) an automobile, (b) a truck, (c) a train, (d) an airplane, (e) a marine vessel, (f) a motorcycle, (g) a bicycle, (h) any one subsection or any combination thereof each of which may include an internal combustion engine, using a fuel for combustion comprising of, gasoline, alcohol, diesel, propane, natural gas, electric; a fuel cell, comprised of any fuel or any combination thereof; an electric motor; a turbine engine; a solar powered motor producing the necessary light illuminated for the operation of the motor; a hybrid engine human powered propulsion comprised of; walking or pedaling.

Modes of a telecommunication configurations, used as a component combined with the transportation system and method for the reconditioning of a vehicle headlight fixture or vehicle headlight fixture lens include, for example, an Internet service, a wireless telecommunication service, a land line telephone network service, a fiber optic television transmission network system, a satellite television transmission network system, a terrestrial radio transmission network system, a short wave radio transmission network system, a portable satellite radio transmission network system, a portable satellite computer transmission network system, a two way radio transmission system a vehicle on board satellite computer transmission network, a stationary computer using a fiber optics network system, a telephone fiber optic network system, a cable television transmission network system, a fiber optic telephone network system.

1-7. (canceled)

8. A portable system for reconditioning a vehicle headlight fixture or vehicle headlight fixture lens on a vehicle having at least one vehicle headlight fixture or vehicle headlight fixture lens in need of reconditioning, comprising:
a vehicle;
tools and equipment necessary for reconditioning a vehicle headlight fixture or vehicle headlight fixture lens; and
instructions for using the tools and equipment to recondition a vehicle headlight fixture or vehicle headlight fixture lens;
wherein the tools and equipment are transported using the vehicle.

9. The portable system of claim 8, wherein a vehicle headlight fixture or vehicle headlight fixture lens is reconditioned without removing the vehicle headlight fixture or vehicle headlight fixture lens from the vehicle having at least one vehicle headlight fixture or vehicle headlight fixture lens.

10. The portable system of claim 8, wherein the vehicle includes any one of the following: an automobile, such a van, box truck, pickup truck, or flatbed truck; a train, an airplane, a marine vessel, a motorcycle, or a bicycle.

11. The portable system of claim 8, wherein the vehicle is propelled by any of the following, either alone or in combination: an internal combustion engine, an electric motor, a turbine engine, a solar powered motor, a hybrid engine, and human powered propulsion.

12. The portable system of claim 8, wherein the tools and equipment include any one or more of the following, alone or in combination: a generator, an air compressor, a power inverter, a 12v battery, an electrical extension cord, a sanding or polishing machine, grit wet sanding paper, a micro finishing compound, a final finish polish, a polishing pad, a squeeze bottle filled with water, a laptop computer, a cell phone.

13. The portable system of claim 12, wherein the instructions include:
(a) using the vehicle equipped with the tools and equipment to travel to the location of a vehicle headlight fixture or vehicle headlight fixture lens in need of reconditioning, or a vehicle having at least one vehicle headlight fixture or vehicle headlight fixture lens in need of reconditioning;
(b) using one sheet of the grit wet sanding paper, in combination with the squeeze bottle of water, and applying water onto the sheet of grit wet sanding paper, thus saturating the grit wet sanding paper;
(c) using the saturated grit wet sanding paper, to apply a rotating type motion against a vehicle headlight fixture or vehicle headlight fixture lens in need of reconditioning until any oxidation or minute scratches present on the vehicle headlight fixture or vehicle headlight fixture lens have been removed;
(d) using the generator to power the sanding or polishing machine, and installing a compound polishing pad onto the sanding or polishing machine;
(e) polishing a vehicle headlight fixture or vehicle headlight fixture lens in need of reconditioning using the sanding or polishing machine on a low setting, while applying a micro finishing compound onto the a vehicle headlight fixture or vehicle headlight fixture lens in need of reconditioning; and
(f) polishing a vehicle headlight fixture or vehicle headlight fixture lens in need of reconditioning using the sanding or polishing machine, while applying the micro finishing compound as needed to remove any scratches away, until a clear scratch-free appearance is achieved.

14. The portable system of claim 8, further comprising a telecommunication system.

15. The portable system of claim 14, wherein the telecommunication system includes at least one of the following: an Internet service, a wireless telecommunication service, a land line telephone network service, a fiber optic television transmission network system, a satellite television transmission network system, a terrestrial radio transmission network system, a short wave radio transmission network system, a portable satellite radio transmission network system, a portable satellite computer transmission network system, a two way radio transmission system a vehicle on board satellite computer transmission network, a stationary computer using a fiber optics network system, a telephone fiber optic network system, a cable television transmission network system, a fiber optic telephone network system.

16. A portable system for reconditioning a vehicle headlight fixture or vehicle headlight fixture lens on a vehicle having at least one vehicle headlight fixture or vehicle headlight fixture lens, comprising:
a mail service, such as a courier service, a freight service, a messenger service;
tools and equipment necessary for reconditioning a vehicle headlight fixture or vehicle headlight fixture lens; and
instructions for using the tools and equipment to recondition a vehicle headlight fixture or vehicle headlight fixture lens;
wherein the tools and equipment are transported using the mail service.

17. The portable system of claim 16, wherein a vehicle headlight fixture or vehicle headlight fixture lens is reconditioned without removing the vehicle headlight fixture or vehicle headlight fixture lens from the vehicle having at least one vehicle headlight fixture or vehicle headlight fixture lens.

18. The portable system of claim 16, wherein the tools and equipment include any one or more of the following, alone or in combination: a generator, an air compressor, a power inverter, a 12v battery, an electrical extension cord, a sanding or polishing machine, grit wet sanding paper, a micro finishing compound, a final finish polish, a polishing pad, a squeeze bottle filled with water, a laptop computer, a cell phone.

19. The portable system of claim 16, wherein the instructions include:
(a) using the vehicle equipped with the tools and equipment to travel to the location of a vehicle headlight fixture or vehicle headlight fixture lens in need of reconditioning, or a vehicle having at least one vehicle headlight fixture or vehicle headlight fixture lens in need of reconditioning;
(b) using one sheet of the grit wet sanding paper, in combination with the squeeze bottle of water, and applying water onto the sheet of grit wet sanding paper, thus saturating the grit wet sanding paper;
(c) using the saturated grit wet sanding paper, to apply a rotating type motion against a vehicle headlight fixture or vehicle headlight fixture lens in need of reconditioning until any oxidation or minute scratches present on the vehicle headlight fixture or vehicle headlight fixture lens have been removed;
(d) using the generator to power the sanding or polishing machine, and installing a compound polishing pad onto the sanding or polishing machine;
(e) polishing a vehicle headlight fixture or vehicle headlight fixture lens in need of reconditioning using the sanding or polishing machine on a low setting, while applying a micro finishing compound onto the a vehicle headlight fixture or vehicle headlight fixture lens in need of reconditioning; and
(f) polishing a vehicle headlight fixture or vehicle headlight fixture lens in need of reconditioning using the sanding or polishing machine, while applying the micro finishing compound as needed to remove any scratches away, until a clear scratch-free appearance is achieved.

20. The portable system of claim 16, further comprising a telecommunication system.

21. The portable system of claim 21, wherein the telecommunication system includes at least one of the following: an Internet service, a wireless telecommunication service, a land line telephone network service, a fiber optic television transmission network system, a satellite television transmission network system, a terrestrial radio transmission network system, a short wave radio transmission network system, a portable satellite radio transmission network system, a portable satellite computer transmission network system, a two way radio transmission system a vehicle on board satellite computer transmission network, a stationary computer using a fiber optics network system, a telephone fiber optic network system, a cable television transmission network system, or a fiber optic telephone network system.
